(19) United States
(12) Patent Application Publication
(10) Pub. No.: US 2007/0053320 A1
(43) Pub. Date: Mar. 8, 2007

(54) Unified entry format for common control signalling

(75) Inventors: Mika P. Rinne, Espoo (FI); Olav Tirkkonen, Helsinki (FI); Tsuyoshi Kashima, Midori-ku (JP); Sigit Puspito Wigati Jarot, Yokohama (JP); Jussi Kahtava, Mitaka-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/509,697

(22) Filed: Aug. 25, 2006

Related U.S. Application Data
(60) Provisional application No. 60/710,892, filed on Aug. 25, 2005.
(60) Provisional application No. 60/796,547, filed on May 2, 2006.

(51) Int. Cl. H04Q 7/00; H04L 12/28

(52) U.S. Cl. 370/329; 370/431

(57) ABSTRACT

An apparatus that provides control channel signalling to a plurality of user terminals is provided. A definition unit is configured to define at least two allocation table formats. A selection unit is configured to select which allocation table format from the at least two allocation formats is to be used to construct an allocation table. A construction unit is configured to construct an allocation table based at least in part, on the selected allocation table format. A transmitter unit is configured to signal the allocation table to a plurality of user terminals, wherein the selected allocation table format is identified by a unified entry in the allocation table.

### CROSS-REFERENCE TO RELATED APPLICATIONS:

This application claims the benefit of U.S. Provisional Application No. 60/710,892, filed on Aug. 25, 2005, and U.S. Provisional Application No. 60/796,547, filed on May 2, 2006, the contents of which are incorporated by reference in their entirety.

### BACKGROUND OF THE INVENTION:

1. Field of the Invention

The present invention relates to a novel Evolved UTRAN (E-UTRAN) air interface technology with efficient sharing of resources assuming fast and reliable common control signalling. The present invention is applicable to other novel air interface technologies as well, where resource sharing will base on similar resource sharing principles.

2. Description of the Related Art

Common Control signalling is one mechanism used to announce resource sharing in a network device such as an allocation table. An Allocation Table can contain descriptions of resource allocations for all active terminals in a given cell for a duration of a frame or for a defined duration of a set of frames. An allocation table is transmitted in downlink of an E-UTRAN system and it indicates which users receive what kind of data resources during the frame in downlink and which users are allowed to transmit on what kind of data resources in uplink during the respective uplink frame. The carrier frequencies of downlink and uplink transmissions may be multiplexed in a Frequency Division Duplex or Time Division Duplex manner. The Allocation Table can include allocation identification and transport format indications for terminals, which will either have downlink or uplink resources allocated during that frame. The allocation table specifically includes allocation identification for the same frame, where it is transmitted itself and describes the allocation of that frame only. Thus, the allocation table is a critical resource for all communication links of a cell/sector and as a common resource of the cell, its format has to be efficient, reliable and unified.

In the prior art, the allocation table arrangement for discontinuous transmission/reception is described without exact formats of the allocation table itself. Other prior art includes allocation tables with pointers to dedicated resources by piggybacked signalling and dedicated headers. An example includes allocation tables which point allocation identification (with Transport Format and resource units) for longer than a single frame period of time, say to any defined set of following frames, for example, current frame +1, current frame +2 up to current frame +N. Further, the pointing may happen, instead of the current frame to any of the more distant frames. Pointing to a frame other than the current frame may be motivated by looser processing time requirements. However, this implies longer round trip time and is typically not preferred. Defining resourcing over longer than a single frame period of time may be motivated by the reduction of signalling overhead, where the resources available are scarce anyway, for example, in a narrow transmission band.

As the allocation table forms common channel for all receivers in the cell, it has to be reliable and decodable by all receivers in the cell coverage area. This means reliable decoding in all conditions of experienced signal-to-noise ratio (SNR), signal-to-interference ratio (SIR), amount of interference from serving cell-to-other cell interference ratio (G-factor) and dominant interference-to-other interference ratio (DIR), in the expected coverage area. And even more, for receivers making hard handover, the allocation table of the adjacent cell (handover target cell) on the same carrier frequency has to be decodable already in the coverage area of the serving cell (handover source cell). Thus, the allocation table has to be decodable in carrier-to-interference (C/I) levels down to about −7 dB.

In prior art 2G/3G, resource allocation is done by dedicated signalling for dedicated resources. To access a dedicated signalling channel, a common channel may be used prior the use of dedicated signalling channel. This will obviously cause some delays. In prior art WLAN, resource allocation is based on carrier sensing of collision and packet scheduling. Protocol headers are thus present in every packet to indicate the receiver, which packets to decode. Decoding of headers of all packets, whether intended to be received or not, consumes power of the terminal receiver.

These prior art means therefore are not sufficient nor efficient enough for E-UTRAN, as it enables much higher symbol rate than prior art systems and therefore comparable signalling delays to prior art are not tolerable here. Also, due to high symbol rate of E-UTRAN, terminal receiver power saving is a vital feature of the transmission system and is not applicable by the mentioned prior art signalling schemes.

The patent application to Mika Rinne and Olav Tirkkonen: “Discontinuous transmission/reception in a communications system” U.S. application Ser. No. 11/068,055 filed Feb. 28, 2005, is incorporated by reference in its entirety.

### SUMMARY OF THE INVENTION

According to an exemplary embodiment of the present invention, an apparatus that provides control channel signalling to a plurality of user terminals is provided. This control channel signalling, structured to instances of frames or a set of frames at a time, may also be called referred to as an Allocation Table. A definition unit is configured to define at least two allocation table formats. A selection unit is configured to select which allocation table format from the at least two allocation formats is to be used to construct an allocation table. A construction unit is configured to construct an allocation table based at least in part, on the selected allocation table format. A transmitter unit is configured to signal the allocation table to a plurality of user terminals, wherein the selected allocation table format is identified by a unified entry in the allocation table.

According to another exemplary embodiment of the present invention, a method for control channel signalling to a plurality of user terminals is provided. At least two allocation table formats are defined. An allocation table format is selected from the at least two allocation formats is to be used to construct an allocation table. An allocation table is constructed based at least in part, on the selected allocation table format. The allocation table is signalled to a plurality of user terminals, wherein the selected allocation table format is identified by a unified entry in the allocation table.

According to another exemplary embodiment of the present invention a system for control channel signalling to a plurality of user terminals, is provided. The system includes a defining means for defining at least two allocation table formats. The system further includes a selecting means for selecting which allocation table format from the at least two allocation formats is to be used to construct an allocation table. The system further includes a constructing means for constructing an allocation table based at least in part, on the selected allocation table format. The system further includes a signalling means for signalling the allocation table to a plurality of user terminals, wherein the selected allocation table format is identified by a unified entry in the allocation table.

According to still another exemplary embodiment of the present invention, a user terminal in a communications system, is provided. A detection unit is configured to detect if the allocation table contains an entry for the user terminal. A decoding unit is configured to decode the allocation table only if the allocation table contains an entry for the user terminal. According to this exemplary embodiment the detection unit detects that the allocation table contains an entry for user terminal by interpreting a unified entry in the allocation table.

According to another exemplary embodiment of the present invention, an apparatus is provided. The apparatus includes a definition unit configured to define at least two allocation table formats, wherein the allocation table include at least two parts that correspond to the allocation formats. A selection unit is configured to select which allocation table format from the at least two allocation formats is to be used to construct an allocation table. A construction unit is configured to construct an allocation table based at least in part, on the selected allocation table format. A transmitter unit is configured to signal the allocation table to a plurality of user terminals, wherein the selected allocation table format is identified by a unified entry in the allocation table. The apparatus provides control channel signalling to a plurality of user terminals.

According to another exemplary embodiment of the present invention, an apparatus is provided. A receiver unit is configured to receive allocation table formats of the allocation table, with the selected allocation table format identified by an unified entry in the allocation table.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1a-c illustrates allocation tables;

FIG. 2 illustrates an example of channel coding and mapping of coded bits to OFDM resources;

FIG. 3 illustrates the allocation table formats with special channel coding applied to the first entry and the allocation table header

FIGS. 4 illustrates an example of the first, second and third fields of a down link control signal for downlink resource allocation; and

FIGS. 5A & 5B illustrate example embodiments of the present invention;

FIG. 6 illustrates another embodiment of the present invention; and

FIG. 7 illustrates another embodiment of the present invention.

### DETAILED DESCRIPTION OF PREFERRED EMBODIMENTS

Reference will now be made to the preferred embodiments of the present invention, examples of which are illustrated in the accompanying drawings. The present invention is a signalling method for a common control channel that provides an allocation table with a unified entry format with a self-decodable channel-coding block arrangement for common control signalling having variable and dynamic configurations of shared allocations.

There are two aspects involved, first the information contents of the common control signalling vary as a function of the number of allocated users, and second allocation information has to be decodable by all receivers despite their expected received symbol energy to interference power. In both aspects, the channel coding structure of the common control signalling has to be either known beforehand, or has to be blind-detectable or has to be signalled outside of the allocation table itself.

The common control signalling according to embodiments of the present invention, is realized as an allocation table which can include a unified entry for every allocation of a receiver in that frame. The channel coding structure of the allocation table can be defined to have two parts. The first part is coded in a unified self-decodable format, which then reveals the format of the latter channel coding block(s). The first part thus includes a defined number of information bits and defined ratio of redundancy, which results a uniquely defined length channel coded block. The latter coding block allows variable information contents, variable number of information bits and variable channel coding rate, as those are identified uniquely in the first part of the allocation table.

Examples of the present invention define at least two different allocation tables with a unified entry format for decoding any of the allocation tables. Embodiments of the present invention provide a unified allocation table format so that only the first entry, of a known size, in the table is always encoded in a specific way, wherein after decoding, a receiver can understand the size and channel coding block structure of the remaining parts of the allocation table, which may be of any size or format. Exemplary embodiments of the present invention also provide for different levels of encoding reliability since a normal channel coding (less redundancy), or more robust channel coding (more redundancy) can be utilized over the remaining part of the allocation table, while still using the unified first entry format.

Blind detection of the allocation table is possible, in another embodiment of the invention. As the allocation table has to be processed fast to be available in the same frame for resource payloads, two possible try-and-test structures is a practical number of alternatives and about four to eight possible try-and-test structures is the maximum.

As the allocation table is a mandatory decodable entity to access any shared resources of the frame, its decoding format should be known. If coding of the allocation table would be signalled outside of the allocation table itself, as the third embodiment of the invention, it should be present in a form such as the system information broadcast. System information bits are very scarce and expensive, and besides they do not repeat frequently, so it is very unlikely that it could delay-efficiently indicate the coding format of the allocation table for every frame.

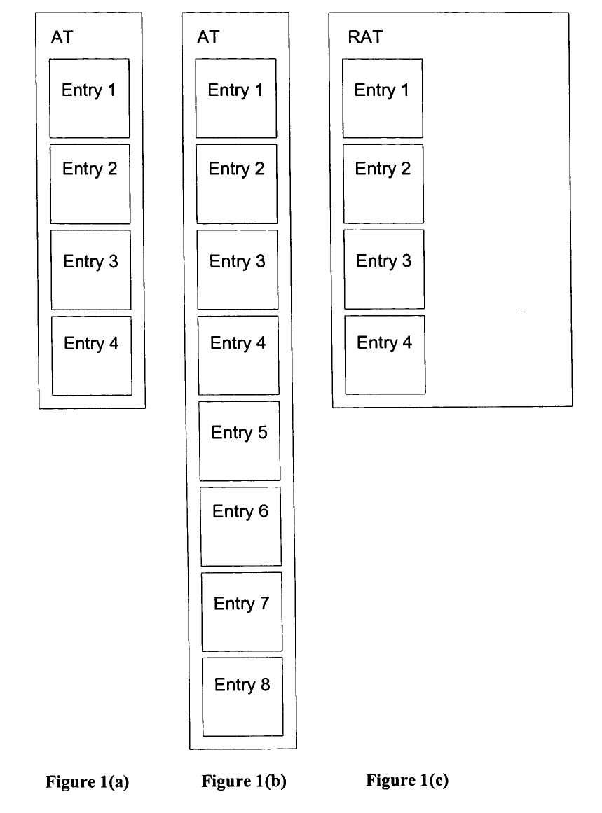

FIGS. 1a-c illustrate examples of allocation tables. A robust allocation table is different from an allocation table by its channel coding, otherwise, the robust allocation table and the allocation table are composed of similar information entries. FIG. 1a shows an allocation table with four entries, FIG. 1b shows an allocation table with eight entries, and FIG. 1c shows a robust allocation table with four entries. The entry is defined to include information of the resource allocation as radio link identifier (RLID) of a terminal to which the resource is allocated, the transport format (TF) of the resource allocation as channel coding modulation and multi-antenna configuration of the allocation. The entry also includes exact indexing of the allocated time-frequency and channelization code symbol resources.

The above mentioned Transport Format indications include exact definitions of the time-, frequency-, channelization code-, scrambling code- or spatial resources allocated to a terminal. It also includes indications of transmission format by means of modulation, channel coding or multi-antenna configuration.

In an alternative arrangement of the allocation table, instead of describing all allocations one-by-one entry-by-entry, there is first a complete list of all RLIDs of all entries, which are going to have allocations during this subframe. And then further, the actual body of each entry, which describes the allocation contents in details, appear separately. The bodies of the entries may thus continue to the second part of the allocation table having variable length. This arrangement will speed up detection by a terminal, because it will already detect from the RLID list in the beginning of the table, whether it has an allocation in that frame or not. Thus the terminal can avoid decoding the second part of the allocation table, unless the RLID list will reveal that there is an allocation for this terminal in this subframe and that allocation is described in details in the entry, whose body is included to the second part of the allocation table.

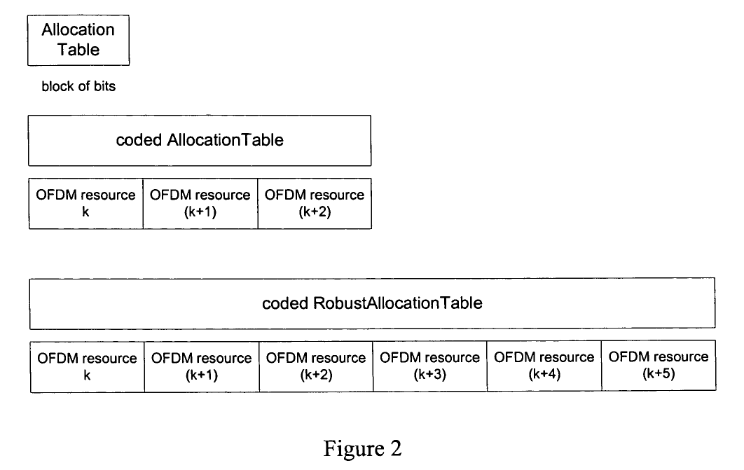

FIG. 2 illustrates an example of channel coding and mapping of coded bits to OFDM resources. These resources may include:

time;

frequency; and

channelization code resources of a multicarrier symbol.

Both the allocation table and the robust allocation table formats are shown in FIG. 2. Once the allocation table entries are formed, the block of bits will be channel coded and modulated to OFDM resources k to (k+2). These resources may be given as full OFDM symbols in time, as the number of subcarrier symbols in frequency over a given OFDM symbol in time, or as a given number of subcarrier symbols in frequency over a given number of OFDM symbols in time. If the robust allocation table format is chosen instead of the normal allocation table format, the same entries as a block of bits will be channel coded and modulated to higher number of OFDM resource k to (k+5).

As the information contents of the allocation table is not constant but depends on the number of entries present in the allocation table, there is an allocation table header needed in the first part of the allocation table to exactly indicate the length of the actual channel coding block of the second part of the allocation table. This allocation table header can be appended to the first entry of the allocation table, which may be for example, a single entry or otherwise of a prior known size. In order to correctly decode the header, the first entry needs to be well protected and it needs to be a self-decodable channel coding block with error detection. The first entry and the header thus form a unified entry format for the full allocation table. After decoding the first entry and the header, a receiver is able to decode all other entries, if present. According to embodiments of the present invention, in a communication system it may be defined that the self-decodable block solely contains the allocation table header and already the first entry is included in the successive code block.

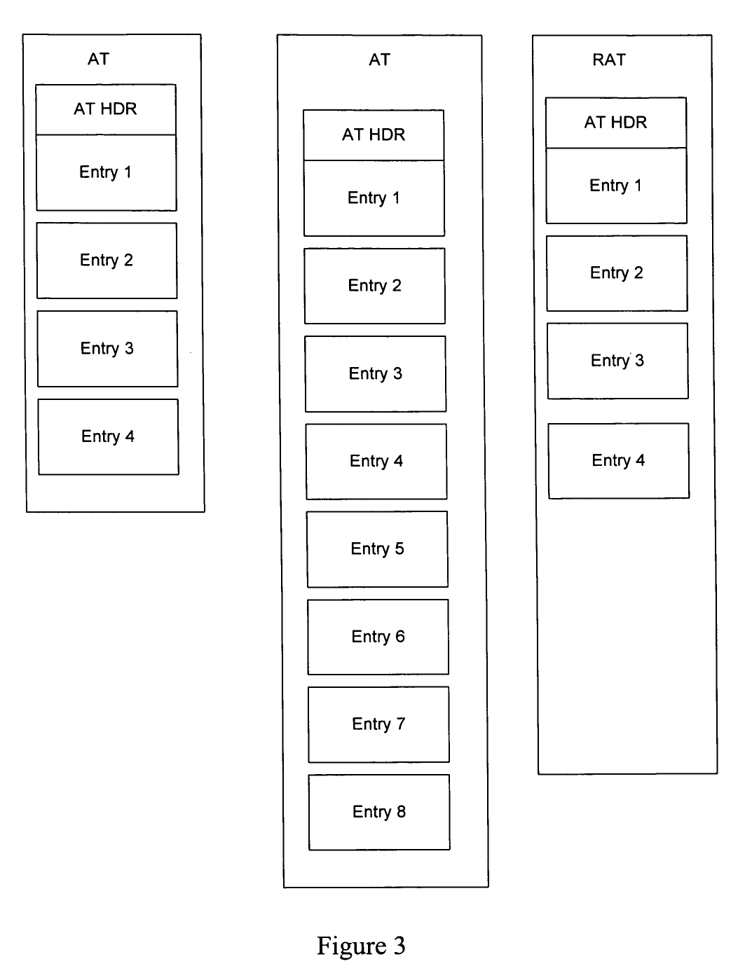

FIG. 3 illustrates the allocation table formats with special channel coding applied to the first entry and the allocation table header. The allocation table header describes the number of successive entries present in the allocation table and their channel coding options. After decoding the unified first entry, the receiver will know exactly how many symbols will form the full allocation table possibly including several separate channel coding block(s).

The first part of the allocation table is required to be correctly decoded by all terminals, that have resources allocated in that given frame. This means that the allocation table has to be transmitted at high power and/or a low channel coding rate (large amount of redundancy bits) is applied. As terminals in a given cell may experience a very large range of received channel interference, it is not optimal to have a very low channel coding rate for every terminal, say at excellent radio connection to the base station. On the other hand, terminals at the cell edge require extremely good channel coding (low channel coding rate) in order to be able to correctly decode the allocation table. Thus, it is favourable to bundle allocation of those terminals to the same part of the allocation table, which favour about equal channel coding to protect the signalling contents of the allocation table, i.e., allocations for the low channel of carrier-to-interference terminals are preferable in the same mutual frame and allocations of the high channel of carrier-to-interference terminals are favourable in the same mutual frame. As the channel carrier-to-interference changes because of mobility and radio propagation dynamics, it is not favourable to have too small range of received channel carrier-to-interference to determine a different allocation table bundle. But clearly there would be benefit to provide at least two different allocation table formats, as a normal allocation table for all other receivers and a robust allocation table for very low channel carrier-to-interference receivers.

For the above mentioned reasons, the allocation table format should be such that it has a unified entry format and need no signalling to identify, which allocation table format is applied at a given transmission frame. This can be implemented by incremental redundancy so that all terminals will decode allocation table from known symbol indexes k to (k+i) and check error detection. In case a robust allocation table was transmitted, the error detection is not possible yet and the receiver needs to continue decoding over symbols k+(i+1) to (k+n). After decoding all symbols from k to (k+n), the robust allocation table is fully received and its error detection may become successful. Incremental redundancy however requires a constant or known number of information bits, which is not the case of an allocation table.

As the robust allocation table format consumes more symbols than the other allocation table format and thus reduces the number of symbols per frame available for the payload, it is preferable to apply robust allocation table formats only for those terminals that really require it for sufficiently high probability of correct decoding. If low channel carrier-to-interference receivers are spread to any frames (any allocation table, or any part of an allocation table), all those allocation tables, or all those parts of an allocation table, must have the most robust format, which decreases cell throughput.

On the other hand, if robust allocation table formats are not applied, the probability of incorrect decoding the allocation table will increase and that means lost opportunities for receiving payload (in downlink) or similarly lost opportunities for transmitting payload (in uplink) of a single user. This is inefficient, because this happens with the payload, whose resource units are already reserved for that user, so that it concretely wastes capacity from all other users. Even more than that, it can cause unnecessary delay for the other terminals to wait for this ‘ghost’ transmission. In downlink, it also caused unnecessary interference to the other cells and consumed unnecessary transmission power, as well. In uplink, the effects of not using the resource that was allocated may mean lost transmission opportunity for another terminal, longer delay for the other terminal and also longer delay for this particular terminal that missed its allocation opportunity.

As every terminal is following its own discontinuous allocation or scheduling rules (e.g. modulo-rule), which dictates the sequence of frames (SFN) that may include its allocation identifications, it is preferable to give the same instances of allocation rule to appear for terminals experiencing similar receiver conditions e.g. low C/I, if otherwise possible. This reduces the need for robust allocation table instances. If the delay requirements of the traffic flows for low C/I terminals are much different, it may be necessary to split their allocation rules to further bundles as low C/I delay class 1 and low C/I delay class 2 etc. However, even in this situation the low C/I terminals of given traffic flow requirements are favourably bundled to the same robust allocation table, as much as possible.

The decision, regarding when to apply a robust allocation table format instead of another allocation table format may be determined e.g. by the following estimates;
ratio of number of terminals that require normal allocation table to the number of terminals which require robust allocation table
ratio of traffic to/from terminals that require normal allocation table to/from terminals which require robust allocation table
delay requirements for traffic flows of terminals that require normal allocation table to terminals that require robust allocation table

Other special groupings of terminals to be signalled in the same frame, such as, by the same allocation table, are possible. Such groupings may be defined based on the capability or configuration of the terminal. For example, if terminal has a single antenna configuration and is non-MIMO capable or if the terminal has a multi-antenna configuration and is MIMO-capable, it is possible to primarily make allocations for them in different frames. i.e. allocations of non-MIMO capable terminals in the same mutual frames (same sets of frames), whereas MIMO capable terminals in the same mutual frames (same sets of frames). This allows any special allocation table coding and mapping so that it is available either for a terminal with single antenna, or it is available for a terminal with multiple antennas from every antenna separately or from all antennas jointly.

According to an exemplary embodiment of the present invention, a method of signalling allocations to users is as follows. A downlink (DL) control signal that includes a plurality of control signal blocks, is provided. In an exemplary embodiment of the invention, different transport formats are applied to or associated with, the plurality of control signal blocks.

The transport format of a first block is sufficiently robust in order to ensure that the coverage requirement is met. For example, the coverage requirement would be set to a very high coverage probability of the order of 95% to 99%, for a block error rate of order 1%. According to an embodiment of the invention, the transport format of the first block is cell specific and is transmitted to all of the UEs through the system information. According to another embodiment of the present invention, the transport format of the first block is standardized and written to the specifications, so that it can be readily programmed into the UE.

The, transport format(s) of the next block(s) of the allocation table, are signalled to UEs in the first block of the allocation table or alternatively they may also be included as fields in the system information. According to the former embodiment of the present invention, the first part of the allocation table may include transport format(s) of all the control blocks from 1 to K, forming the allocation table, or alternatively, the n-th control signal block has an indicator for the transport format of the successive (n+1)-th control signal block, for blocks 2 to K. The indicator identifies the existence and transport format indicator (TFI) of the (n+1)-th control signal block. If the maximum number of blocks, K, is known to UEs, there is no need for the format field in the last K-th control signal block.

According to an exemplary embodiment of the present invention, the control signal blocks, which contain resource allocation information on which UEs use which PRBs, also includes at least one entry existence indicator (EEI) bit. Each EEI bit corresponds to one physical resource block (PRB) and indicates whether the PRB is allocated (EEI=‘1’), to a certain UE/to certain UEs by this control signal block or not (EEI=‘0’). Thus, if the PRB is not allocated to any UE in this control signal block, it may be empty (not used at all), or the allocation of this PRB is signalled by another control signal block, or the allocation of this PRB was signalled in another sub-frame etc, the EEI bit indicates the PRB is not allocated. Multiple UEs may share a PRB if a distributed allocation is used, or if there is a multi-user MIMO transmission.

In addition to the EEI indicating whether a PRB is allocated or not in the given channel coding block, there may be an Overall Entry Existence Indicator (OEEI) signalled in the first channel coding block. The OEEI indicates whether or not the PRB in question is allocated in any of the channel coding blocks of the allocation table in this sub-frame. If it is not allocated, it means that the PRB is not used at all, or the allocation of this PRB was signalled in another sub-frame, or using out-of-band signalling, etc.

According to one exemplary embodiment of the invention, there is a field in each control signal block with UE entries identifying UEs that resources may be allocated to in the control signal block. These entries indicate at least the radio link identities (also referred to as UE identities), and possibly other relevant information such as the transport format, HARQ information etc. There is a mapping from the set of UEs that may be allocated in the block to a set of UE indices. This mapping may be either explicit or implicit, based on the order of the UE entries, or out-band signalling. With out-of-band signalling, the addressing space of the UE indices may be enlarged to refer to UEs that do not have a UE entry indicating a UE identity in the control signal block in question. According to this exemplary embodiment, the size of the addressing space of the UE indexes equals the number of UEs that may be allocated in the control signal block.

In another exemplary embodiment of the present invention, the addressing space of the UE indexes would also have an index indicating that the PRB is not allocated in this control block. Thus, the space of UE indexes would be enlarged with the EEI bit. There is an UE index entry in the field that indicates which UE gets which PRB. In this field, the UE index entry in the (n+1)-th control block for each of the resources not indicated in blocks 1, 2 . . . n. The advantage of this exemplary embodiment is that a separate EEI field is not needed. However, the addressing space of the UE index would be one bit larger than in the preferred embodiment, and that a UE index entry would be needed for each PRB in the field.

As discussed above, in a preferred embodiment of the present invention, there is a field in the control signal block with UE indexes that indicate which UE gets allocations in which PRB. Thus, there is a UE index entry only for the PRBs with the corresponding allocations indicated by the EEI. The UE index entry indicates that the PRB is allocated in this control signal block for PRBs with EEI set to ‘1’. The field of UE indexes may be encoded using any of the compression schemes of the prior art.

The (n+1)-th control signal block signals the resource allocation on the PRBs, on which the resource allocation is not indicated by block 1, 2, . . . n. In other words, the resource allocation on only the remaining PRBs, is signalled. This information is available from EEI bits of the block 1, 2, . . . n and possibly the OEEI.

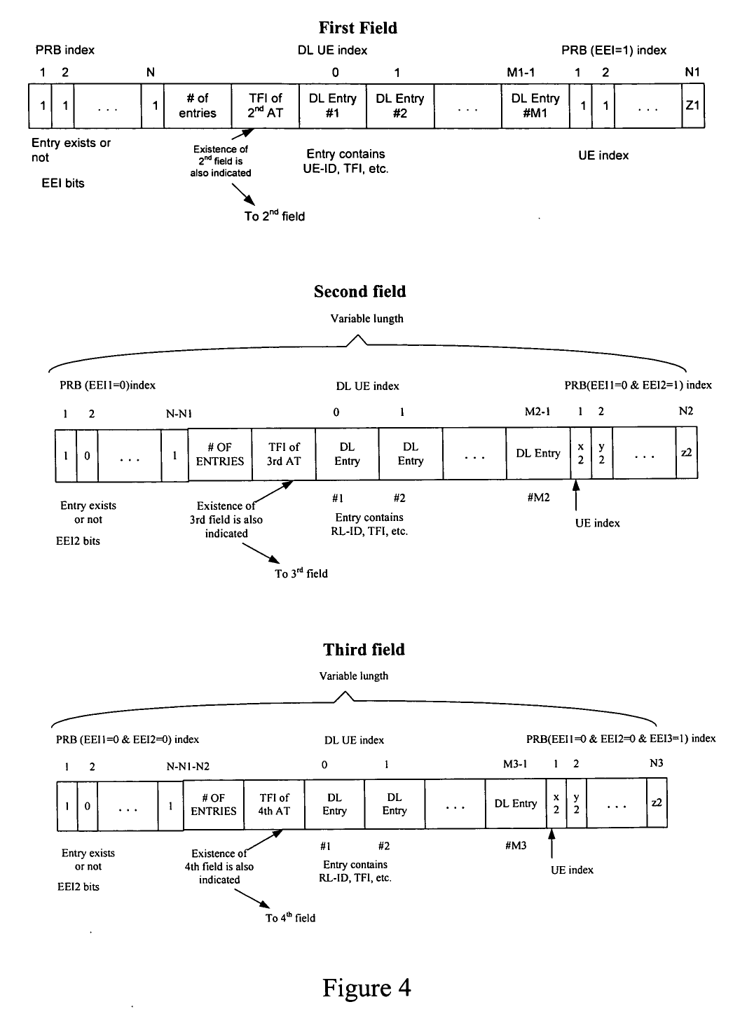

FIG. 4 is an illustration of the control signal block signals according to an exemplary embodiment of the present invention. According to this example there are three control signal blocks 1-3. In this example the following assumptions are made:

There are N PRBs.
Downlink entry contains the radio link ID (also referred to as UEID) and all necessary transport information for the indicated UE;
Transport format of the control signal block 1 is known in advance by the UE;
The resource allocation of N1 PRBs (out of N PRBs) is signalled by the control signal block 1;
The allocation of M1 UEs to N1 resource blocks is signalled by the control signal block 1; ‘The resource allocation of N2 PRBs (out of N-N1 PRBS) is signalled by the control signal block 2
The allocation of M2 UEs to N2 resource blocks is signalled by the control signal block 2;
The resource allocation of N3 PRBs (out of N-N1-N2 PRBs) is signalled by the control signal block 3.
The allocation of M3 UEs to N3 resource blocks is signalled by the control signal block 3.

TFI in the control signal block 3 indicates that there is no control signal block following it, or alternatively the TFI of this last block may be omitted, as discussed above.

Thus, as shown in FIG. 4 the UEs are divided among three groups 1-3 based at least in part on UE channel conditions such as for example path-loss or carrier-to-interference ratio. According to exemplary embodiments of the present invention, the downlink (DL) control signal includes common control signals, the control signal for DL resource allocations of several UEs, and the control signal for uplink (UL) resource allocations of several UEs. Thus, it is possible to apply different transport formats to different UEs. The result of which reduced overhead of the control signal while maintaining all of the required information coverage. Thus, according to this embodiment of the present invention, the transport format of the 1^{st} field of the resource allocation structure would be the most robust. The advantage of this embodiment is that the 1^{st} field can indicate the allocations of all PRBs if a few of the UEs, utilize the whole system bandwidth.

Another advantage of embodiments of the present invention is scheduling flexibility of the control signal itself as well as the associated data.

According to other embodiments of the present invention, other special groupings of the UEs are possible. Such groupings include, but are not limited to, the configuration or capability of the UE. For example, if the UE has a single antenna configuration or is non-MIMO capable or if the terminal has a multi-antenna configuration and is MIMO capable, allocations may be made for these UEs in different frames for UEs that are MIMO capable are allocated in a first frame and resources for non-MIMO capable UEs are allocated in a second frame.

How many frames and what kind of frame sequences are allocated for non-MIMO, for MIMO, for high C/I, for low C/I depends on the mutual ratio of active terminals appearing each time in the cell and also about their transmission needs and traffic flow requirements.

The Allocation Table header in the first part of the table could define the transport format for the second part of the table, such as Type of channel code (turbo, convolutional etc); channel coding rate (such as ⅛, ⅙, ¼, ⅓, ½, . . . ); Indication if outer code is in use, (yes/no); type of the outer-code, (Reed Solomon, Golay, Hamming or other block code); block length of the block code; type of error detection, (such as for example, CRC); length of error detection (such as for example, 12 bits); and channel coded block length (number of entries).

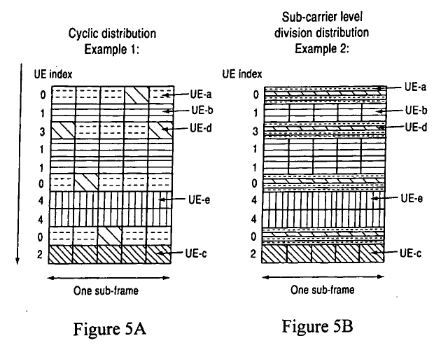

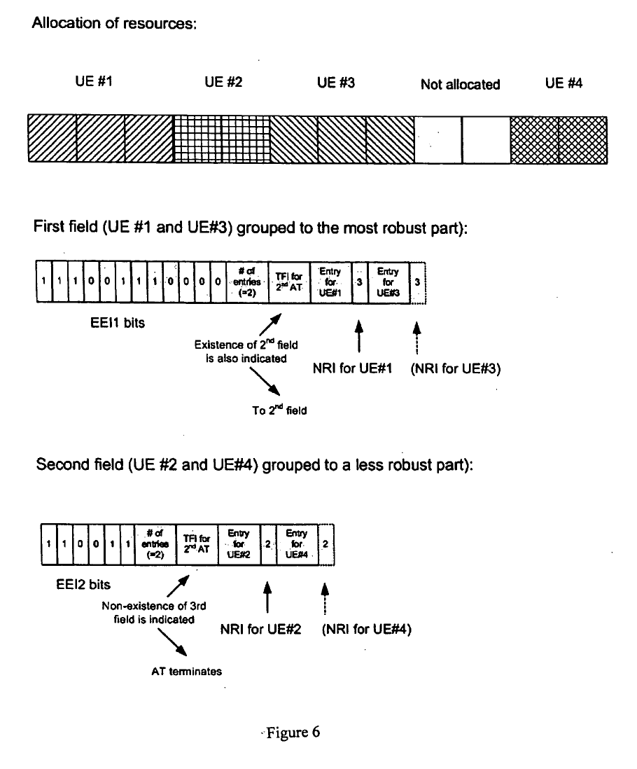

FIGS. 5A and 5B illustrate other exemplary embodiments of the present invention. According to this embodiment, as illustrated in FIG. 6, the allocated resources may be either localized virtual resource blocks (l-VRB), or distributed virtual resource blocks (d-VRB), or a set of multiplexed l-VRBs and d-VRBs. The VRBs may constructed by various means that are known in the art. The signalling related to how a variable set of localized and distributed VRBs are constructed from PRBs may be implemented in the first control signal block for all PRBs that are allocated in the Allocation Table, or it can be made separately in each control signal block for the resources that are allocated in that control signal block. For example, the documents “3GPP, R1-060305, NTT DoCoMo and Nokia, Distributed FDMA Transmission for Shared Data Channel in E-UTRA Downlink”, and “Amended Control for Resource Allocation in a Radio Access Network” EP 06111410.4 filed Mar. 20, 2006, discuss various methods to construct VRBs from PRBs, and to multiplex l-VRBs and d-VRBs. These documents are incorporated by reference in their entirety. According to this exemplary embodiment, a pre-defined method to construct distributed resource blocks may be used together with an indication of the number of d-VRBs, to identify distributed VRBs from localized VRBs. Examples of the pre-defined methods are illustrated in FIGS. 5A & 5B. According to one example as shown in FIG. 5A, a cyclic distribution constructs d-VRBs cyclically from the symbols in a sub-frame and the PRBs used for distributed transmission. According to another example as shown in FIG. 5B, a subcarrier level division constructs d-VRBs in a pre-defined manner, by sharing whole subcarriers during a sub-frame to a d-VRB.

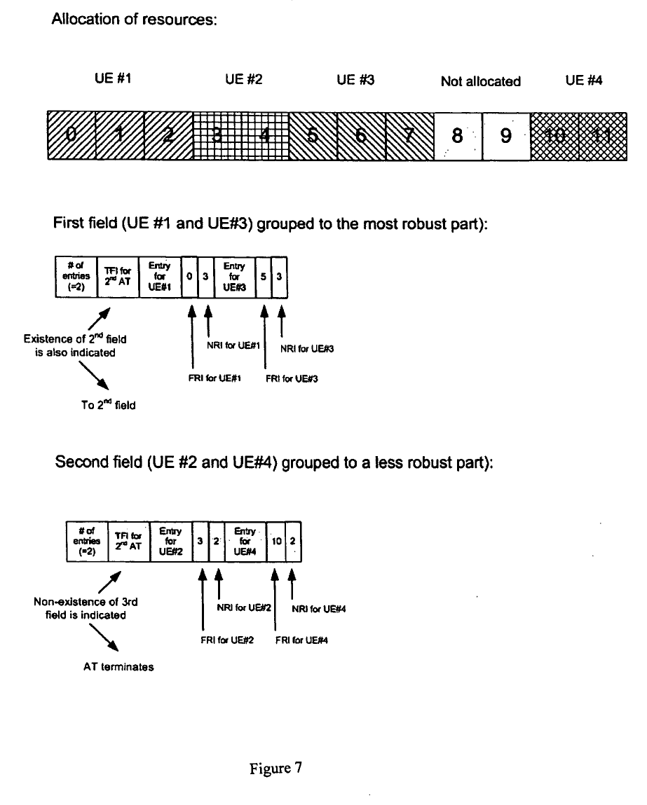

FIGS. 6 and 7 illustrate other exemplary embodiments of the present invention. In the examples discussed above, there are no constraints when allocating PRBs to users. In some systems such as for example Long Term Evolution (LTE) UL, it may preferable to allocate only a set of consecutive resource blocks to a user or, allocate consecutive resource blocks to a user after making a pre-determined ordering. Methods known in prior art to simplify allocation information when only consecutive resources can be allocated to a user may be used. For example, the document 3GPP R1-060573, Ericsson, NTT DoCoMo, “E-UTRA Downlink Control Signaling—Overhead Assessment” discusses two methods to signal allocations of consecutive resources. This reference is incorporated by reference in its entirety. In the exemplary embodiments according to this invention, these methods are used to signal allocations of consecutive resources. In the first example, in FIG. 6, for each UE, the first allocated resource is indicated by a first resource indicator (FRI) field, and the number of allocated resources in a number of resources indicator (NRI) field. In a solution according to this invention, the UEs may be grouped to multiple parts, and there may be a field indicating the existence and possibly the transport format of the next part. The second exemplary embodiment of the present invention is illustrated in FIG. 7. The implementation of this embodiment is included in “Method for indicating and detecting transmission resource allocations in a multi-user communication system”. The order of the UE-specific entries is used to indicate the resource allocation: Then only the NRI information needs to be signalled. According to this invention, the allocation signalling may be divided into multiple parts, and the EEI or OEEIs may be used to limit the scope of the allocation signalling in each part. Note that in an embodiment according to FIG. 7, the last NRI field in each part carries redundant information, and needs not be transmitted. Thus, the present invention may be utilized if either there is full freedom to allocate resources to users or, if there are some constraints to the allocation.

It should be appreciated by one skilled in art, that the present invention may be utilized in any device that implements the allocation table formats with a unified entry for decoding the allocation table. The foregoing description has been directed to specific embodiments of this invention. It will be apparent, however, that other variations and modifications may be made to the described embodiments, with the attainment of some or all of their advantages. For example, embodiments of the present invention may include, but are not limited to, hardware, software, ASICs, modules, and computer-readable code embodied on a computer-readable medium. Therefore, it is the object of the appended claims to cover all such variations and modifications as come within the true spirit and scope of the invention.

What is claimed:

1. An apparatus comprising:
definition unit configured to define at least two allocation table formats;
selection unit configured to select which allocation table format from the at least two allocation formats is to be used to construct an allocation table;
construction unit configured to construct an allocation table based at least in part, on the selected allocation table format;
transmitter unit configured to signal the allocation table to a plurality of user terminals, wherein the selected allocation table format is identified by a unified entry in the allocation table; and
wherein the apparatus provides control channel signalling to a plurality of user terminals.

2. The apparatus of claim 1, further comprising:
grouping unit configured to group a plurality of user terminals, thereby forming user terminal groups; and
a second definition unit configured to define the allocation table formats based on the user terminal groups.

3. The apparatus of claim 2, further comprising:
coding unit configured to execute joint-coding over a configured group of a plurality of user terminals.

4. The apparatus of claim 2, wherein the grouping unit is configured to group a plurality of user terminals based on at least one physical resource.

5. The apparatus of claim 1, wherein transmitter unit is configured to signal the allocation table to the plurality of user terminals and to provide a separate header that identifies whether a user terminal of the plurality of user terminals has an entry in the allocation table.

6. The apparatus of claim 2, wherein the transmitter unit is further configured to transmit at least one entry existence indicator bit.

7. The apparatus of claim 1, wherein in the definition unit, the defined allocation table format is previously known by the plurality of user terminals.

8. The apparatus of claim 1, wherein in the definition unit, the defined allocation table format is signalled outside of the allocation table.

9. The apparatus of claim 1, wherein in the definition unit, the defined allocation table format is made blind-detectable by the plurality of user terminals.

10. A method for control channel signalling, the method comprising:
defining at least two allocation table formats;
selecting which allocation table format from the at least two allocation formats is to be used to construct an allocation table;
constructing an allocation table based upon a selected allocation table format; and
signalling the allocation table to a plurality of user terminals, wherein the selected allocation table format is identified by a unified entry in the allocation table,

11. The method of claim 10, further comprising:
grouping a plurality of user terminals, thereby forming user terminal groups; and
defining the allocation table formats based on the user terminal groups.

12. The method of claim 11, wherein the grouping a plurality of use terminals is based on at least one physical resource.

13. The method of claim 10, wherein the signalling the allocation table to the plurality of user terminals includes providing a separate header that identifies whether a user terminal of the plurality of user terminals has an entry in the allocation table.

14. The method of claim 11, wherein signalling the allocation table to a plurality of user terminals includes transmitting at least one entry existence indicator bit.

15. The method of claim 10, wherein the allocation table format is previously known by all of the user terminals.

16. The method of claim 10, wherein the allocation table format is signalled outside of the allocation table.

17. A system comprising:
defining means for defining at least two allocation table formats;
selecting means for selecting which allocation table format from the at least two allocation formats is to be used to construct an allocation table;
constructing means for constructing an allocation table based at least in part, on the selected allocation table format; and
signalling means for signalling the allocation table to a plurality of user terminals, wherein the selected allocation table format is identified by a unified entry in the allocation table.

18. The system of claim 17, further comprising:
grouping means for grouping a plurality of user terminals, thereby forming user terminal groups; and
defining means for defining the allocation table formats based on the user terminal groups.

19. The system of claim 18, wherein grouping means groups a plurality of use terminals based on based on at least one physical resource.

20. The system of claim 18, wherein signalling means signals the allocation table to the plurality of user terminals includes providing a separate header that identifies whether a user terminal of the plurality of user terminals has an entry in the allocation table.

21. The system of claim 18, wherein signalling means transmits at least one entry existence indicator bit.

22. The system of claim 17, wherein in the defining means, the allocation format is previously known by the plurality of user terminals.

23. The system of claim 17, wherein in the defining means the allocation format is signalled outside of the allocation table.

24. A user terminal comprising:
detection unit configured to detect if the allocation table contains an entry for the user terminal
decoding unit configured to decode the allocation table only if the allocation table contains an entry for the user terminal,
wherein the detection unit detects if the allocation table contains an entry for user terminal by interpreting a unified entry in the allocation table.

25. An apparatus comprising:
definition unit configured to define at least two allocation table formats, wherein the allocation table include at least two parts that correspond to the allocation formats;
selection unit configured to select which allocation table format from the at least two allocation formats is to be used to construct an allocation table;
construction unit configured to construct an allocation table based at least in part, on the selected allocation table format; and
transmitter unit configured to signal the allocation table to a plurality of user terminals, wherein the selected allocation table format is identified by a unified entry in the allocation table,
wherein the apparatus provides control channel signalling to a plurality of user terminals.

26. The apparatus of claim 25, further comprising:
grouping unit configured to group a plurality of user terminals, thereby forming user terminal groups; and
a second definition unit configured to define the allocation table formats based on the user terminal groups.

27. The apparatus of claim 26, wherein the grouping unit is configured to group a plurality of user terminals based on at least one physical resource.

28. The apparatus of claim 25, wherein transmitter unit is configured to signal the allocation table to the plurality of user terminals and to provide a separate header that identifies whether a user terminal of the plurality of user terminals has an entry in the allocation table.

29. The apparatus of claim 26, wherein the transmitter unit is further configured to transmit at least one entry existence indicator bit.

30. The apparatus of claim 25, wherein in the definition unit, the defined allocation table format is previously known by the plurality of user terminals.

31. The apparatus of claim 25, wherein in the definition unit, the defined allocation table format is signalled outside of the allocation table.

32. An apparatus comprising:
A receiver unit configured to receive allocation table formats of the allocation table, with the selected allocation table format identified by an unified entry in the allocation table.
